(19) United States
(12) Patent Application Publication
(10) Pub. No.: US 2006/0100879 A1
(43) Pub. Date: May 11, 2006

(54) Method and communication device for handling data records by speech recognition

(76) Inventors: Jens Jakobsen, Bochum (DE); Kai Froese, Dusseldorf (DE); Andrea Finke-Anlauff, Braunschweig (DE)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/516,870

(22) PCT Filed: Jul. 2, 2002
(86) PCT No.: PCT/IB02/02557

§ 371 Date: Aug. 25, 2005

(51) Int. Cl. G10L 21/00

(52) U.S. Cl. 704/270

(57) ABSTRACT

The present invention relates to a mobile communication device having a speech recognition for selecting and activating device function by acoustic input. Particularly, the present invention relates to a backup method to be used in case of failure of the speech recognition offering an advantageous method for selecting and activating the device functions operable with speech recognition by operation of switches and keys in an easy and fast way. The device functions, i.e. especially dialing of telephone numbers, are organized in data records. On receiving a user input, a list of the data records is displayed to the user. On receiving a further user input, one of the displayed list of data records is identified and an instruction is transmitted to at least one of several applications executed on the mobile communication device. The instruction commands the receiving application to operate in accordance with the transmitted instruction in order to cause the respective device function of the mobile communication device. Exemplary, the instruction may include a telephone number to be dialed which is transmitted to a dialing application causing on receiving the telephone number the establishment of a telephone communication link.

The present invention relates to a mobile communication device, and more particular to a mobile communication device comprising an improved speech recognition for operating its functionality.

The convenience provided by mobile phones to be operated within different situations in combination with the freedom of movement is one of the features causing the wide spread and general acceptance of the mobile phones within the population. In parallel, the number of applications and device functions provided by mobile phones to the users increase rapidly with each generation. The increasing number of applications and device functions result from the increasing capabilities of the hardware implemented in the mobile phones and the demand of the user for easier handling of mobile phones.

An advantageous feature in combination with the handling of a mobile phone is a speech or voice recognition, respectively. The speech recognition takes into account the circumstances that modern mobile phones store up to several of hundreds telephone numbers being stored in an implemented telephone directory. The speech recognition improves efficiently the selection of the one desired telephone number. Especially, the increasing acceptance of headsets also suggests itself and prefers the use of speech recognition. The use of headsets further makes the handling of a mobile phone more easier, since mobile phones are usually carried in jacket or trouser pockets and the establishing of a telephone call by a mobile phone having connected a headset via speech recognition prevents the user from fishing out the mobile phone from the pockets.

Usually, a limited selection of telephone numbers comprised in the telephone directory is associated with recorded voice tags which have been previously entered by a user within a certain training mode. An acoustic input of the user corresponding to a certain recorded voice tag results in a dialing of the associated telephone number in order to establish a communication link to this phone number.

The speech recognition algorithms are limited in their performance in noisy environments especially in noisy environments within the space of a motor vehicle, e.g. parking on a service area at a busy highway, on loud and noisy streets, e.g. in a pedestrian precinct heavily populated or in case the voice of the speaker is affected by a disease such as an ordinary cold. In such performance liming situations a further advantageous operational method backing up the speech recognition is of special interest.

The object of the invention is to provide a method and a mobile communication device for handling data records of a mobile communication device selectable by speech recognition.

The inventive concept has several advantages offered to a user of a mobile communication device having the capability of speech recognition. In case of a failed speech recognition of an acoustic input of the user by the mobile communication device the present inventive concept offers a fast, reliable and easy to use method to activate manually the desired function of those usually activated by speech recognition. An important aspect thereof is fast and easy manual access in order to provide a back-up method to access functions operable with speech recognition. The user browses easily through a list of telephone directory entries having assigned voice tags and selects an entry to dial the corresponding telephone number. The manual selection implies the operation of a few keys or switches easily operable by the user without supervising it.

Moreover, usually the number of voice tags for speech recognition is limited due to the memory capacity of the mobile communication device and since an ordinary user is only capable to remember a limited number of voice tags, e.g. about ten voice tags. Therefore, the speech recognition is used for important and/or often used telephone directory entries to be dialed. The manual selection of the telephone directory entries guarantees a fast access to these important and often used telephone numbers.

Additionally, the speech recognition shall not be limited to the accessing of telephone directory entries but shall also allow to operate certain device functions and/or device application functions. Analogously, voice tags are assigned to device functions and/or device application functions or to instructions controlling the device functions and/or device application fuctions, respectively.

The objects of the invention are attained by a method, a computer program and a mobile communication device which are characterized by what is claimed in the accompanying independent claims. Further embodiments of the invention are the subject of the corresponding dependent claims.

According to an embodiment of the invention, a method for handling data records of a mobile communication device is provided. The data records are selectable by speech input and recognition, that is the data records are recallable by speech recognition causing a pre-defined operation on the mobile communication device. At first, a first user input is received. A list of the data records is displayed in accordance with the first user input to the user. In the following, a second user input is received. The second user input identifies one of the displayed data records. Finally, an instruction associated with the identified data record is transmitted to one of the applications executed on the mobile communication device. These applications control the functions of the mobile communication device and the transmitted instructions instruct the receiving application to operate correspondingly thereto.

According to an embodiment of the invention, an initial user input is received. The initial user input instructs the mobile communication device to operate a speech recognition application in order to be prepared for an acoustic input which is to be analyzed by the speech recognition application for identifying a corresponding data record.

According to an embodiment of the invention, at least one voice tag is associated to each of the data records in order to be identified by the speech recognition.

According to an embodiment of the invention, at least one designation is associated to each of the data records. The designation is to be displayed to the user for selecting one of the data records.

According to an embodiment of the invention, the data records are distinguished into a first set of data records and a second set of data records. The first set of data records comprises telephone directory entries each of which include at least a designation and a telephone number. The second set of data records comprises device functions and device application functions. Each data record of the second set comprises an instruction causing the operation of the respective device functions and device application functions and a designation thereto.

According to an embodiment of the invention, the first user input has two possible values, a first input value and a second input value. In case the value of the first user input equals the first input value, a list of the first set of data records is displayed to the user. In case the first user input equals the second input value, a list of the second set of data records to displayed to the user.

According to an embodiment of the invention, the data records of the first set of data records are arranged in a pre-determined sequence. Further, the displaying of the list of the first set of data records comprises a displaying of at least one data records of the first set. On receiving of a browsing input by the user, at least one subsequent or at least one preceding data record of the first set of data records relative to the presently displayed one is displayed. The browsing input has two browsing input values, a first browsing value and a second browsing value. The receiving of the first browsing value causes the displaying of the subsequent data records, whereas the receiving of the second browsing value causes the displaying of the preceding data record.

According to an embodiment of the invention, the data records of the second set of data records are arranged in a pre-determined sequence. Further, the displaying of the list of the second set of data records comprises a displaying of at least one data records of the first set. On receiving of a browsing input by the user, at least one subsequent or at least one preceding data record of the second set of data records relative to the presently displayed one is displayed. The browsing input has two browsing input values, a first browsing value and a second browsing value. The receiving of the first browsing input value causes the displaying of the subsequent data record, whereas the receiving of the second browsing input value causes the displaying of the preceding data record.

According to an embodiment of the invention, a software tool for handling data records of a mobile communication device selectable by speech recognition is provided. The software tool comprises program portions for carrying out the operations of the aforementioned methods when the software tool is implemented in a computer program and/or executed.

According to an embodiment of the invention, there is provided a computer program for handling data records of a mobile communication device selectable by speech recognition. The computer program comprises program code sections for carrying out the operations of the aforementioned methods when the program is executed on a processing device a computer, a processing device or a network device.

According to an embodiment of the invention, a computer program product is provided which comprises program code portions stored on a computer readable medium for carrying out the aforementioned methods when said program product is executed on a processing device, a computer or a network device.

According to an embodiment of the invention, a mobile communication device for handling data records of a mobile communication device selectable by speech recognition is provided. The mobile communication device includes a plurality of applications executable thereon and the data records each have assigned at least one voice tag. The voice tags are employed for speech recognition. Additionally, the mobile communication device further includes a speech recognition component for recognizing acoustic input via a microphone. Preferably, the speech recognition component is a speech recognition application comprised in the plurality of applications executable on the mobile communication device. The speech recognition allows to select one data record of the list of data records by comparing the acoustic input with the assigned voice tags.

A first actuator allows a user to activate the speech recognition component, i.e. to instruct the mobile communication device to be prepared for receiving an acoustic input to be processed by the speech recognition component A second actuator is operable with the speech recognition component. The second actuator allows a user to initiate a displaying of a list of data records on a display coupled to the mobile communication device. Advantageously, the at least one data record of the list of the data records is displayed on the display to the user. Further, a third actuator allows a user to select one data record of the displayed list of the data records, wherein the selection of the data record causes a transmission of the instruction comprised in the selected data record an a corresponding application to be operated in accordance with the transmitted instruction.

According to an embodiment of the invention, each of the data records includes at least a designation and an instruction. Preferably, the designations are textual or symbolic designations allowing a user to identify the data record and being adapted for display.

According to an embodiment of the invention, the data records are divided into a first set of data records and a second set of data records. The first set of data records comprises information dedicated to a dialing application for dialing telephone numbers. Preferably, the first set of data records comprises telephone directory entries associated with voice tags. The second set of data records comprises information dedicated to ether applications to control further applications in accordance with the instructions comprised in the data records of the second set of data records. Moreover, the second actuator operable with the speech recognition component enables a user to initiate the displaying either of a list of the first set or of a list of the second set of data records.

According to an embodiment of the invention, the first input signal causes a displaying of at least one data record of the list of the first set of data records, being arranged in a pre-determined sequence. The second actuator is further operable with the speech recognition component in order to generate either a first browsing signal or a second browsing signal. The first browsing signal causes a displaying of at least one subsequent data record of the first set of data records relative to the presently displayed at least one data record. The second browsing signal causes a displaying of at least one preceding data record of the first set of data records relative to the presently at least one displayed data record.

According to an embodiment of the invention, the second input signal causes a displaying of at least one data record of the list of the second set of data records, being arranged in a pre-determined sequence. The second actuator is further operable with the speech recognition component in order to generate either a first browsing signal or a second browsing signal. The first browsing signal causes a display of at least one subsequent data record of the second set of data records relative to the presently displayed at least one data record. The second browsing signal causes a display of at least one preceding data record of the second set of data records relative to the presently at least one displayed data record.

According to an embodiment of the invention, the second actuator is a multiple switching component able to cause at least two different signals upon operation of a user.

The invention will be described in greater detail by the means of preferred embodiments with reference to the accompanying drawings, in which

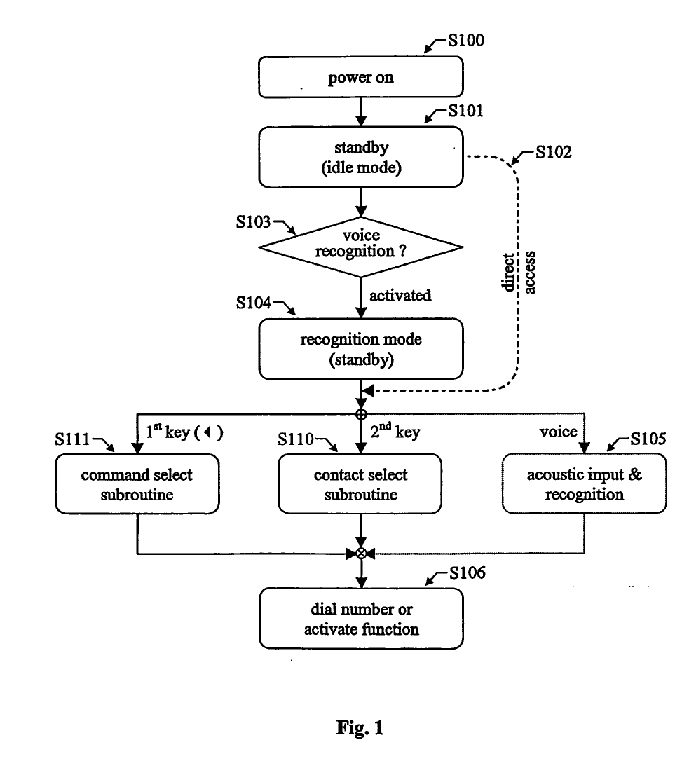

FIG. 1a shows a flow diagram illustrating an operational sequence according to an embodiment of the invention:

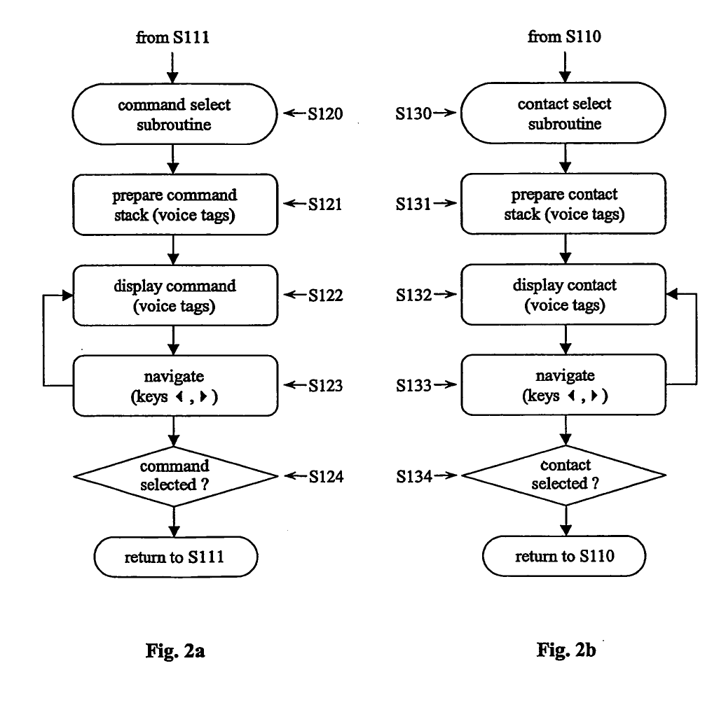

FIG. 2a shows a flow diagram illustrating a first operation subsequence comprised in the operational sequence depicted in FIG. 1 according to an embodiment of the invention;

FIG. 2b shows a flow diagram illustrating a second operation subsequence comprised in the operational sequence depicted in FIG. 1 according to an embodiment of the invention;

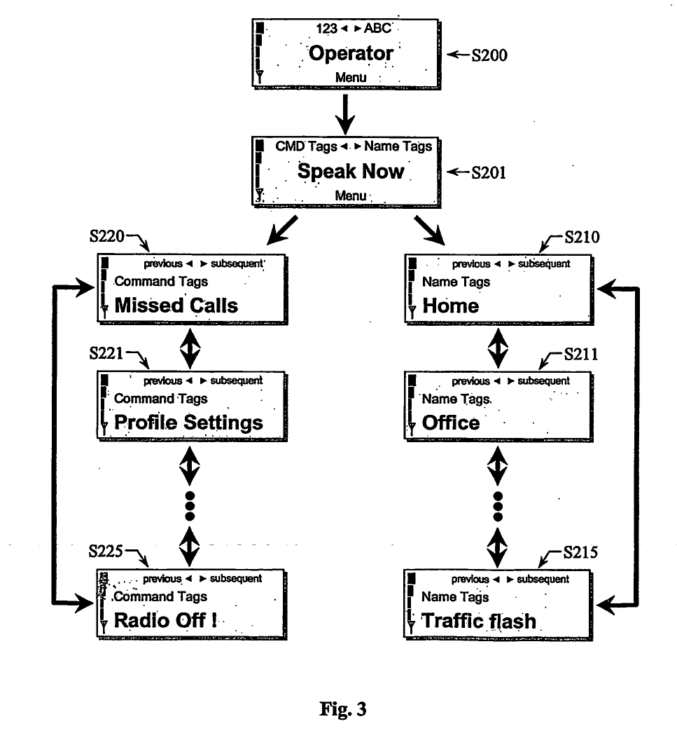

FIG. 3 shows a flow diagram illustrating a sequence of displays presented to a user operating a mobile communication device according to an embodiment of the invention; and

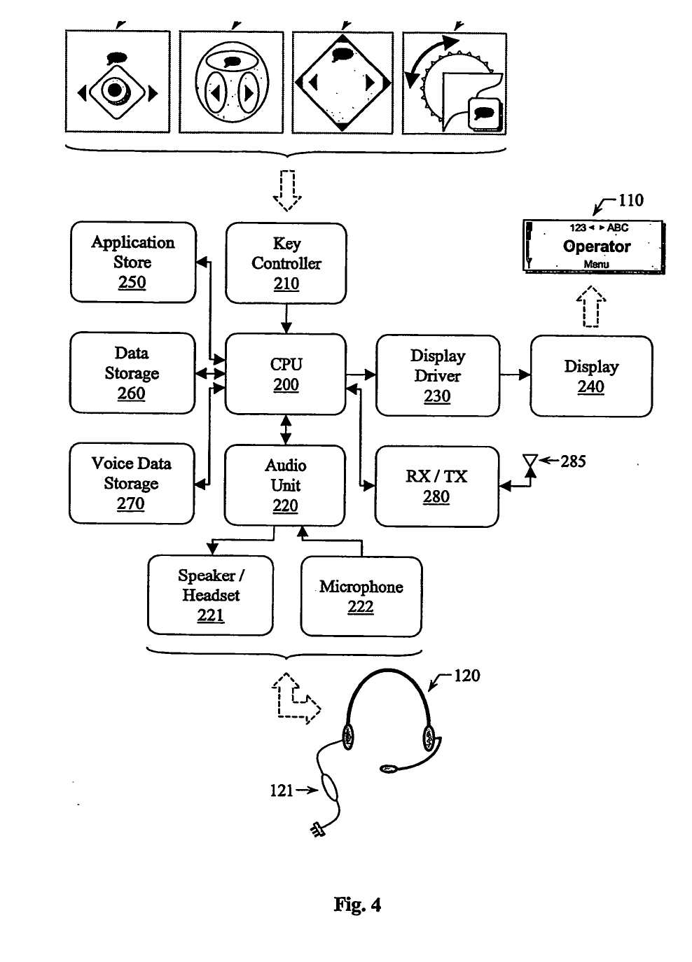

FIG. 4 shows a block diagram illustrating components of a mobile communication device adapted to operate the aforementioned operations according to an embodiment of the invention.

The following description relates to mobile communication devices and the method according to embodiments of the invention. Same or equal parts shown in the figures will be referred by the same reference numerals.

The following FIG. 1 in combination with FIG. 2a and FIG. 2b illustrates an exemplary operational sequence implemented and executed in a mobile communication device with respect to the present invention and in accordance with the inventive concept.

The reference is directed to FIG. 1 illustrating the exemplary operational sequence in a first perspective.

In a first operation S100, the mobile communication device is switched on. In an operation S101, the mobile communication is operated in a standby or idle mode, respectively. In this idle mode, a mobile communication device is at least able to receive incoming signals with the antenna via a cellular communication network and to receive user input entered by a user via the keyboard or keypad of the mobile communication device.

Preferably, the entered user input is dedicated to a user interface of the mobile communication device to control or operate device applications and device functions of the mobile communication device. Moreover, the entered user input is interpreted as an instruction instructing to activate a certain application executable on the mobile communication device.

In an operation S103, a certain entered user input leads to the activation of a speech or voice recognition, respectively. The respective user input is preferably generated by operation of a dedicated activation key or by selecting a certain item of the user interface of the mobile communication device. The dedicated activation key may be connected externally to the mobile communication device, such as implemented in a cable of a headset or in an external key control board e.g. of a free-hand installation in a motor vehicle.

In an operation S104, the speech recognition is activated and is prepared for an acoustic input of the user. The speech recognition receives the acoustic input preferably recorded via a microphone implemented in the mobile communication device or connected externally to the mobile communication device, e.g. a microphone of a headset or a microphone of a free-hand installation implemented in the dashboard of the motor vehicle.

In an operation S105, an acoustic input is identified and recorded. This acoustic input is preferably compared with a set of stored voice tags. Conventionally, voice tags for speech recognition have to be inputted by a user, preferably in a certain training mode previous to the speech recognition. Inputting and training of voice tags offers the possibility to a user to define arbitrary user selected speech phrases as voice tags. Further conventionally, the voice tags are assigned to a telephone number entry in the telephone directory implemented in the mobile communication device.

In case of correspondence of the acoustic input inputted by the user with one of the pre-stored voice tags, the telephone number to which the corresponding voice tag has been assigned is transmitted to a dialing application to be dialed in order to establish a telephone communication to the dialed counterpart telephone.

Moreover, in accordance with the concept of the present invention, the speech recognition is not only employed to support the telephone number dialing operation of the mobile communication device but also to operate further device functions or to control device applications executed on the mobile communication device. Analogous to the association of voice tags and selected telephone directory entries, voice tags are assigned to instructions to control device functions. Both the instructions and the assigned voice tags are preferably defined by user input. The device functions and device applications associated with voice tags to be controlled by speech recognition shall be organized logically in a directory similar to the telephone directory and the set of these device functions and device applications will be termed in the following as function directory.

The following operations S110 and S111 are exemplary backup operations according to an embodiment of the invention. Preferably, the operations S110 and S111 are operable with the speech recognition mode described with reference to operation S104. The operations S110 and S111 are activated by user input, respectively, e.g. by operation of function keys, i.e. navigation keys dedicated for browsing or navigating through the user interface of the mobile communication device, respectively. Here, an operation of a first navigation key “ [symbol] ” by the user results in carrying on with operation S111 of the operations referred to in FIG. 1, whereas an operation of a second navigation key “ [symbol] ”* by the user results in carrying on with operation S110 of the operations referred to in FIG. 1.*see FIG. 1

Moreover, the operations S110 and S111 may also be activated (S102) in the standby or idle mode of the mobile communication device of operation S101, respectively. The activation of either the operation S110 or the operation S111 may be operable with corresponding menu items of the user interface of the mobile communication device.

In the operation S110, a list of telephone directory entries or contacts is displayed to the user of the mobile communication interface, respectively. The displayed entries relate to the set telephone directory entries comprised in the total telephone directory embedded in the mobile communication device, which are selectable by speech recognition. The user has the possibility to select one of the displayed telephone directory entries by a user input for instructing to transmit a telephone number associated to the selected entry to the dialing application in order to establish a telephone communication via the dialed counterpart telephone.

In an operation S111, a list of device functions and device application functions is displayed to the user of the mobile communication interface. The displayed device functions and device application functions relate to device functions or device applications to be controlled by speech recognition and hence relate to the function directory described above. The user has the possibility to select one of the displayed function directory entries by a user input for instructing to transmit a corresponding instruction to an application controlling the selected device function or to the selected device application to be controlled in accordance with the instruction.

The operations S110 and S111 are described in greater detail with reference to FIG. 2a and FIG. 2b which will be described below.

In an operation S106, the application controlling the device function or the application to be controlled receives the selected instruction.

In case the operation S106 is executed subsequently to operation S105 or operation S110, respectively, the dialing application is addressed, the dialing of a telephone number in accordance with the selected telephone directory entry is initiated and a communication is established. Preferably, the completion of the communication leads to the return of the depicted operational sequence to operation S101, i.e. to the standby or idle mode of the mobile communication device, respectively.

In case the operation S106 is executed subsequently to operation S111, the application addressed by the instruction associated to the selected device function or device application function receives the instruction and the control of the mobile communication device is handed over to the addressed application. Preferably, the completion of the process caused by the instruction leads finally to the return of the operational sequence to operation S101.

The reference is directed to FIG. 2a and FIG. 2b illustrating the operation S110 and the operation S111 in greater detail respectively. The illustrated exemplary operational sequences of the FIG. 2a and FIG. 2b differs only in a few details.

FIG. 2a depicts a first operational subsequence comprised in the operational sequence depicted in FIG. 1 according to an embodiment of the invention.

In an operation S120, the operation for offering a list of device functions and device application functions of the mobile communication interface and for selecting a list of items to be executed is started. Advantageously, the list comprises and is limited to listed items which can be selected and activated alternatively by speech recognition as described with reference to operation S105 illustrated in FIG. 1. The list represents the aforementioned function directory comprising the device functions and device application functions to be actuated by speech recognition. The following operations are operations which are carried out in combination with operation S111 depicted and described in FIG. 1.

In an operation S121, the list, the list items or the function dire entries are prepared to be displayed, respectively. The entries are adapted to be displayed to a user. Preferably, the entries comprise textual designations or symbolic designations to be displayed and illustrative of the device functions and device application functions to be controlled. More preferably, the designations term uniquely and/or in an easy understandable way the respective device functions and device application functions. The designations may be similar or equal to the designations of items of the user interface of the mobile communication device, selecting of which causes comparable or the same results. Advantageously, the displayed designations or entries are associated uniquely to the device functions and device application functions to be controlled.

In an operation S122, a first designation or a set of first designations relating to function directory entries is displayed to the user on a display coupled to the mobile communication device, respectively. The number of designations displayable to the user is dependent of the design of the display, i.e. on the number of displayable text rows. One of the displayed designations is presently selected.

In an operation S123, the user of the mobile communication device browses through the list using the navigation keys “ [symbol] ” and “ [symbol] ”. The function directory entries and hence also the designations associated to the entries are arranged in a pre-determined sequence. The operation of one of the navigation keys either instructs to select a subsequent or a preceding designation of the function directory relative to the presently selected one. Advantageously, the selection of a subsequent or a preceding designation comprises a displaying of the newly selected designation. Moreover, the selecting comprises a scrolling of the displayed set of designations, a new arrangement of the set of designations to be displayed and the like.

The operations S122 and S123 are repeated until a certain designation desired by the user is presently selected.

In an operation S124, a user input causes that the device functions or device application functions associated with the presently selected designation is to be operated, respectively. More precisely, the user input instructs to transmit an instruction associated to the presently selected designation to the corresponding addressed application controlling the device function or to the corresponding addressed device application in order to operated in accordance with the instruction, respectively. The operation of the operational sequence is returned to operation S111 or to operation S106 of the operational sequence depicted in FIG. 1.

FIG. 2b depicts a second operation subsequence comprised in the operational sequence depicted in FIG. 1 according to an embodiment of the invention

In an operation S130, the operation for offering a list of contacts of the mobile communication interface and for selecting a contact to be dialed is started. Advantageously, the list of contacts comprises and is limited to contacts which can be selected and activated alternatively by speech recognition as described with referee to operation S105 illustrated in FIG. 1. The following operations are operations which are carried out in combination with operation S110 depicted and described in FIG. 1.

In an operation S131, the list and the contacts are prepared to be displayed, respectively. The contacts are adapted to be displayed to a user. Preferably, the contacts comprises textual designations or symbolic designations to be displayed and illustrative of the contacts and more preferably, the designations are the telephone directory entries defined previously by the user.

In an operation S132, a first contact or a set of first contacts is displayed to the user on a display coupled to the mobile communication device, respectively. The number of contacts displayable to the user is dependent of the design of the display, i.e. on the number of displayable text rows. One of the displayed contacts is presently selected.

In an operation S133, the user of the mobile communication device browses through the list of contacts using the navigation keys “ [symbol] ” and “ [symbol] ”. The contacts are arranged in a pre-determined sequence. The operation of one of the navigation keys either instructs to select a subsequent or a preceding contact relative to the presently selected one. Advantageously, the selection of a subsequent or a preceding designation comprises a displaying of the newly selected contact.

Moreover, the selecting comprises a scrolling of the displayed set of contacts, a new arrangement of the set of contacts to be displayed and the like.

The operations S132 and S133 are repeated until a certain contact desired by the user is presently selected.

In an operation S134, a user input causes that the telephone number associated with the presently selected contact is to be dialed. More precisely, the user input instructs to transit a telephone number associated to the presently selected contact to the dialing application in order to establish a telephone communication. The operation of the operational sequence is returned to operation S110 or to operation S106 of the operational sequence depicted in FIG. 1.

It shall be noted, that the navigation keys operable to navigate through the contact list and the list of device functions and device application functions are also operable with the initiating of the manual selecting operations referred in FIG. 1 with respect to operation S104.

The operational sequences referred to in FIG. 1 and in FIG. 2a as well as in FIG. 2b are amplified by the illustrations presented in FIG. 3. FIG. 3 illustrates exemplary screen contents of a display implemented in the mobile communication device or connected externally to the mobile communication device according to an embodiment of the invention. References will be made to FIG. 1 as well as to FIG. 2a and FIG. 2b in order to complete the aforementioned operational sequences.

In an operation S200, an exemplary screen content of a mobile communication device in the standby or idle mode is depicted The depicted screen content relates to the operation S101 shown in FIG. 1.

In an operation S201, an exemplary screen content of a mobile communication device in the speech recognition mode is depicted. The depicted screen content relates to the operation S102 shown in FIG. 1. The textual tern “Speak Now” indicates to the user that the mobile communication device is prepared to receive an acoustic input to be analyzed and compared with stored voice tags for speech recognition. The top display row indicates the alternative manual selection of contacts or device functions and device applications, respectively as described in the operations S110 and S111 shown in FIG. 1, respectively.

Here, the left part of the top row informs the user that the navigation key “ [symbol] ” allows to select by user input a device function or a device application comprised in the list of device functions and device applications associated with a voice tag to be controlled, i.e. comprised in the aforementioned function directory, whereas the right part of the top row informs the user that the navigation key “ [symbol] ” allows to select by user input a contact comprised in the list of contacts associated with a voice tag to be dialed. The selection by user input will be termed in the following as manual input in order to emphasize the difference of the activation of the respective list entries to speech recognition.

In an operation S220, a first exemplary screen content of a mobile communication device in the manual selection mode of device functions and device applications is depicted. A first item of the list of device functions and, device applications associated with voice tags is displayed. The exemplary device function or device application termed “Missed Calls” informs the user that the selection of this item results in the recalling of missed telephone calls. The term “Missed Calls” represents exemplary one of the aforementioned designations of device functions or device applications, respectively.

In an operation S221, a second exemplary screen content of a mobile communication device in the manual selection mode of device functions and device applications is depicted. The exemplary device function or device application termed “Profile Settings” informs the user that the selection of this item results in the recalling of the profile setting menu allowing the user to adapt the mobile communication device to a selection of pre-defined profile settings. The term “Profile Settings” represents exemplary a fiercer designation of a device function or a device application, respectively.

In an operation S225, a further exemplary screen content of a mobile communication device in the manual selection mode of device functions and device applications is depicted. The exemplary device function or device application termed “Radio Off!” informs the user that the selection of this item results in the switching off of a radio implemented or coupled to the mobile communication device. The term “Radio Off!” represents exemplary a further designation of a device function or a device application, respectively.

The operations S220, S221 and S225 illustrate exemplary device functions and device applications to be controlled. The sequence of the screen contents in S220, S221 and S225 is operated in accordance with the operations S122 to S123 illustrated in FIG. 2a and described with reference thereto. The top row informs the user of the navigation Emotions assigned to the navigation keys “ [symbol] ” and “ [symbol] ”, respectively. The middle text row of the screen contents informs the user how to browse through the items relating to device functions and device applications to be controlled.

In an operation S210, an exemplary screen content of a mobile communication device in the manual selection mode of contacts is depicted. The exemplary contact termed “Home” informs the user that the selection of this item results in the dialing of the home telephone number.

In an operation S211, an exemplary screen content of a mobile communication device in the manual selection mode of contacts is depicted. The exemplary contact termed “Office” informs the user that the selection of this item results in the dialing of the office telephone number.

In an operation S215, an exemplary screen content of a mobile communication device in the manual selection mode of contacts is depicted. The exemplary contact termed “Traffic Flash” informs the user that the selection of this item results in the dialing of the telephone number of a traffic flash service.

The operations S210, S211 and S215 illustrate exemplary telephone directory entries to be dialed. The sequence of the screen contents in S210, S211 and S215 is operated in accordance with the operations S132 to S133 illustrated in FIG. 2b and described with reference thereto. The top row informs the user of the navigation functions assigned to the navigation keys “ [symbol] ” and “ [symbol] ”, respectively. The middle text row of the screen contents informs the user how to browse trough the telephone directory entries to be dialed.

It shall be noted that the browsing operation described by the operations S122 and S123 or the operations S132 and S133, respectively, may be extended by further operations for handling the entries of the respective lists, i.e. the function directory and the telephone directory. Entries of the respective list may be removed on user input. Further additional entries may be added by user input to the respective list or directory, respectively. Advantageously, a voice tag associated with a certain list entry may be reproduced on user input in order to inform a user about a forgotten voice tag. Further advantageously, the user may be allowed to record a voice tag, e.g. to record a acoustic phrase which is easier to be remembered.

FIG. 4 illustrates components implemented in the mobile communication device or coupled to the mobile communication device for operating the aforementioned operational sequences according to an embodiment of the invention. The illustrated components are implemented internally in the mobile communication device or coupled externally thereto. The depicted components include a key controller 210, a central processing unit 200, an audio unit 220, a display driver 230 controlling a display 240, a transceiver unit (RX/TX) 280 connected to an antenna 285, and an application store 250, a data storage 260 and a voice data storage 270.

The processing unit 200 executes the applications of the mobile communication device contained in the application store 250. Preferably, the applications of application store 250 comprise at least a speech recognition application and an application comprising instructions for carrying out the aforementioned method according to an embodiment of the invention.

The data storage 260 comprises a telephone directory preferably organized in a plurality of data records each including a designation or telephone directory entry, respectively, and a telephone number. Further the data storage 260 comprises a function directory organized in a plurality of data records each including a designation and an instruction for controlling a device function or a device application in accordance with the above described method.

Voice data storage 270 stores voice tags associated with a selection of telephone directory entries and with a selection of function directory entries. The voice tags are used during the speech recognition to identify an acoustic input of the user therewith. The data records of the selection of telephone directory entries and selection of function directory entries identifiable and selectable by acoustic input and speech recognition comprises at least a link to the respective voice tag. Preferably, the voice tags are inputted and trained by the means of a particular voice tag defining application. More preferably, the voice tags are specially encoded acoustic inputs.

The distinction between data storage 260 and voice data storage 270 is not necessary since a common storage allows to store both data and voice data. The differentiation between them may be understood as a simplification of the description which shall not be understood as limiting of the present invention thereto.

The audio unit 220 provides a connectivity to speakers, headphones and a microphone or a headset containing headphones and microphone for reproducing an audio signal and for recording an audio signal. Therefore, the audio unit 220 integrates at least amplifiers, an analog to digital converter (ADC) and a digital to analog converter (DAC). The analog to digital converter (ADC) performs the converting of an acoustic signal detected by the microphone to a digital coded data sequence representing the analog signal and the digital to analog converter (DAC) performs the reproducing of a digital coded data sequence by converting the sequence into an analog audio signal. Further the audio unit provides additionally a connectivity to an external microphone and an external speaker such as employed in a headset or in free-hand installations e.g. to be arranged in motor vehicles. The FIG. 4 illustrates a headset 120 including a microphone and headphones connected detachably and externally to the mobile communication device. Advantageously, the cable of the headset 120 has implemented a switch console including a multiple switch or a plurality of switches for remote controlling a selection of device functions.

Further, a selection of different navigation keys are depicted in FIG. 4. Each of the depicted navigation keys allows a user to input at least three different signals.

A first depiction 100 shall illustrate a joystick switch operable into different direction to generate switch signals which are associated to certain functions. The operation of the joystick into an upward direction indicated by the symbol “ [symbol] ” causes a user input relating to the activation of the speech recognition mode as described in operations S101 and S103 shown in FIG. 1. The symbols in left and right direction, i.e. the symbols “ [symbol] ” and “ [symbol] ”, relates to the aforementioned navigation key functions. This is, a operation in the left or right direction causes a user input relating to the selecting of the manual selecting mode of operations S110 and S111, respectively, and the browsing through the respective directory, i.e. either the telephone directory or the function directory.

A second depiction 101 shall illustrate a multiple switch including at least three single switches. Each of the single switches is associated again either to the activation of the speech recognition (indicated by symbol “ [symbol] ”) or to the selecting and browsing function (indicated by symbols “ [symbol] ” and “ [symbol] ”).

A third depiction 102 shall illustrate a multiple tumble or toggle switch having at least three different switching positions. Each of the switching positions is associated again either to the activation of the speech recognition (indicated by symbol “ [symbol] ”) or to the selecting and browsing function (indicated by symbols “ [symbol] ” and “ [symbol] ”).

A fourth depiction 103 shall illustrate a wheel switch and an additional single key. Preferably, both the switch and the key are integrated in a common switch console. The operation of the key having the symbol printing “ [symbol] ” causes a user input relating to the activation of the speech recognition mode. The turning of the wheel switch into a fist direction or into a second direction causes user inputs relating to the selecting of the manual selecting mode and the browsing through the respective directory, respectively. The tuning of the wheel switch into the first direction corresponds to the operation of a navigation key in a first position, e.g. indicated by symbol “ [symbol] ”, whereas the turning of the wheel switch into the second direction corresponds to the operation of a navigation key in a second position, e.g. indicated by symbol “ [symbol] ”.

The signals caused by user operation of one of the presented keys and switches are transmitted to the key controller generating corresponding logical signals to be transmitted to the respective application expecting a user input.

Common status information, a user interface, application specific interfaces and further application related information are displayed via the display driver 230 and the display 240 to the user. The display driver 230 comprises adequate means for generating graphics, text, numbers and symbols on the display. In particular, the display is able to display screen content in accordance with the aforementioned method and more particularly the screen contents depicted in FIG. 3. Exemplary, a screen content 110 corresponding to the screen content S200 shown in FIG. 3 is illustrated.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matter of the structure and arrangements of parts within the principles of the present invention to the full extend indicated by the broad general meaning of the terms in which the appended claims are expressed. For example, the particular elements may vary depending on the particular application for handling data records of a mobile communication device selectable by speech recognition while maintaining substantially the same functionality without departing from the scope and the spirit of the present invention.

Further, although the invention has been illustrated as implemented in circuit block and flow diagram, those skilled in the art will recognize that the invention may be implemented in any hardware, software or hybrid systems.

1. Method for handling data records of a mobile communication device,
wherein at least one pre-stored voice tag is assigned to each of said data records, wherein said voice tags are employed for speech recognition to enable selection of said data records by speech input and recognition on the basis of said voice tags;
wherein said data records comprise a first set of data records and a second set of data records, wherein both sets of data records relate to different applications of said communication device;
said method comprising:
receiving an initial user input causing said mobile communication device to be prepared for receiving an acoustic input to perform said speech recognition thereon;
receiving a first manual user input by a multiple switching component, which is capable to exhibit a first input value and a second input value;
displaying a list of said first or said second set of data records in accordance with said first input signal and said second input signal of said first user input;
receiving a second manual user input identifying one data record of said displayed data records; and
transmitting an instruction comprised in said identified data record to at least one application of a plurality of applications executable on said mobile communication device.

2. Method according to claim 1, wherein data records of said first set each comprise at least one instruction dedicated to a dialing application for dialing a telephone number comprised in said instruction, wherein said first set of data records represents a selection of telephone directory entries, wherein data records of said second set each comprise at least one instruction dedicated to control functions of one or more further applications executed on said mobile communication device in accordance with said instruction, wherein said second set of data records represents a selection of device functions and device application functions.

3. Method according to claim 1, characterized in that at least one designation is assigned to each of the data records, said designation being displayable.

4. Method according to claim 1, comprising:
displaying an indication to said user that an alternative manual user input is operable when receiving said initial user input.

5. Method according to claim 1, wherein said displaying of said list of said first set of data records being arranged in a pre-determined sequence comprises:
displaying at least one data record of said list of said first set of data records;
receiving a browsing input capable to exhibit a first browsing value and a second browsing value;
in case said browsing input corresponds to said first browsing value, displaying at least one data record subsequent to said at least one displayed data record; and
in case said browsing input corresponds to said second browsing value, displaying at least one data record preceding to said at least one displayed data record.

6. Method according to claim 1, wherein said displaying of said list of said second set of data records being arranged in a pre-determined sequence comprises:
displaying at least one data record of said list of said second set of data records;
receiving a browsing input capable to exhibit a first browsing value and a second browsing value;
in case said browsing input corresponds to a first browsing value, displaying at least one data record subsequent to said at least one displayed data record; and
in case said browsing input corresponds to a second browsing value, displaying at least one data record preceding to said at least one displayed data record.

7. Software tool for handling data records of a mobile communication device selectable by speech recognition, comprising program code means for carrying out the steps of claim 1, when said program is run on a processing device, a computer and/or a mobile communication device.

8. Computer program comprising program code means stored on a computer readable medium for carrying out the method for handling data records of a mobile communication device selectable by speech recognition of claim 1 when said program product is run on a processing device, a computer and/or a mobile communication device.

9. Computer program product comprising program code means stored on a computer readable medium for carrying out the method for handling data records of a mobile communication device selectable by speech recognition of claim 1, when said program product is run on a processing device, a computer and/or a mobile communication device.

10. Mobile communication device for handling data records of a mobile communication device which are selectable by speech input and recognition, comprising:
a plurality of applications executable on said mobile communication device;
at least one pre-stored voice tag for speech recognition is assigned to each of said data records having assigned, wherein said voice tags are employed for speech recognition to enable selection of said data records by speech input and recognition on the basis of said voice tags;
said data records comprising a first set of data records and a second set of data records, wherein both sets of data records relate to different applications of said communication device;
a speech recognition component for recognizing acoustic input via a microphone resulting in a selection of one of said data records in accordance with said acoustic input;
a first actuator for activating said speech recognition component;
a second actuator being a said multiple switching component capable to generate a first input signal and a second input signal, said second actuator being operable with said speech recognition mode component causing displaying of a list of said first or said second set of said data records on said display in accordance with said first input signal and said second input signal; and
a third actuator for selecting one data record of said displayed list and for transmitting an instruction comprised in said selected data record to at least one of the plurality of applications to be operated in accordance with said instruction.

11. Mobile communication device according to claim 10, wherein data records of said first set each comprise at least one instruction dedicated to a dialing application for dialing a telephone number comprised in said instruction, wherein said first set of data records represents a selection of telephone directory entries, wherein data records of said second set each comprise at least one instruction dedicated to control functions of one or more further applications executed on said mobile communication device in accordance with said instruction, wherein said second set of data records represents a selection of device functions and device application functions;

12. Mobile communication device according to claim 10, comprising:
said set of data records each comprising at least one designation, said designations being for display.

13. Mobile communication device according to claim 10, wherein said first actuator for activating said speech recognition component causes a display to indicate to a user that an alternative manual user input is operable.

14. Mobile communication device according to claim 10, wherein said first input signal causes a display of a at least one data record of said list of said first set of data records, said first set of data records being arranged in a pre-determined sequence, wherein:
said second actuator operable with said speech recognition component generates a first browsing signal and a second browsing signal;
in case said displaying of said at least one data record of said first set of data records has been initiated:
said first browsing signal causes a displaying of at least one subsequent data record of said first set on said display; and
said second browsing signal causes a displaying of at least one preceding data record of said first set on said display.

15. Mobile communication device according to claim 10, wherein said second input signal causes a displaying of at least one data record of said list of said second set of data records, said second set of data records being arranged in a pre-determined sequence, further comprising:
said second actuator being operable with said speech recognition component for generating a first browsing signal and a second browsing signal;
in case said displaying of said at least one data record of said second set of data records has been initiated:
said first browsing signal causing a displaying of at least one subsequent data record of said second set on said display; and
said second browsing signal causing a displaying of at least one preceding data record of said second set on said display.

16. Mobile communication device according to claim 10, wherein said second actuator is able to generate at least two different signals upon input of a user.
